(19) United States
(12) Patent Application Publication
(10) Pub. No.: US 2021/0304228 A1
(43) Pub. Date: Sep. 30, 2021

(54) METHOD OF INFORMATION PROCESSING, ELECTRONIC DEVICE, AND COMPUTER PROGRAM PRODUCT

(71) Applicant: NEC CORPORATION, Tokyo (JP)

(72) Inventors: Lvye Cui, Beijing (CN); Lu Feng, Beijing (CN); Chunchen Liu, Beijing (CN)

(73) Assignee: NEC CORPORATION, Tokyo (JP)

(21) Appl. No.: 17/218,562

(22) Filed: Mar. 31, 2021

(30) Foreign Application Priority Data
Mar. 31, 2020 (CN) 202010246073.4

(51) Int. Cl. G06Q 30/02

(52) U.S. Cl. CPC G06Q 30/0201; G06Q 30/0204

(57) ABSTRACT

Embodiments of the present disclosure provide a method of information processing, electronic device, and computer program product. The method comprises: obtaining a popularity level of a product and values of a plurality of attributes associated with the product; determining a plurality of influence factors of the plurality of attributes on the popularity level of the product by applying the popularity level and the values of the plurality of attributes to a data processing model; and determining, based on the plurality of influence factors, to adjust at least one attribute of the plurality of attributes to increase the popularity level of the product. Under the guidance of the embodiments of the present disclosure, a supplier of a product can effectively increase a popularity level of a product.

### FIELD

Embodiments of the present disclosure generally relate to a computer technology or information processing technology, and more specifically, to a method of information processing, an electronic device, and a computer program product.

### BACKGROUND

In a broad sense, a product refers to any article produced. A product may also be any article supplied to the market as a commodity and used or consumed by people to satisfy a certain demand of people, including: a tangible article, an intangible service, organization or concept, or a combination thereof. From another perspective, a product may be a result of “a group of associated or interacting actions for converting an input into an output,” namely a result of a “process.” Moreover, a product may refer to a function or service for operation created to meet the market needs, or a valuable article or service for the purpose of use.

Typically, a popularity level of a certain product may refer to a popularity degree of the product among all possible users, which can embody the penetration of the product, user's satisfaction with the product, the competitiveness of the product, the ranking position of the supplier of the product in the industry, and the like. As a result, a supplier of a product is always trying to increase the popularity level of the product.

### SUMMARY

Embodiments of the present disclosure relate to a method of information processing, electronic device and computer program product.

In a first aspect of the present disclosure, there is provided a method of information processing. The method comprises obtaining a popularity level of a product and values of a plurality of attributes associated with the product; determining a plurality of influence factors of the plurality of attributes on the popularity level of the product by applying the popularity level and the values of the plurality of attributes to a data processing model; and determining, based on the plurality of influence factors, to adjust at least one attribute of the plurality of attributes to increase the popularity level of the product.

In a second aspect of the present disclosure, there is provided an electronic device. The electronic device comprises at least one processor, and at least one memory storing thereon computer program instructions. The at least one memory and the computer program instructions are configured, together with the at least one processor, to cause the electronic device to obtain a popularity level of a product and values of a plurality of attributes associated with the product; determine a plurality of influence factors of the plurality of attributes on the popularity level of the product by applying the popularity level and the values of the plurality of attributes to a data processing model; and determine, based on the plurality of influence factors, to adjust at least one attribute of the plurality of attributes to increase the popularity level of the product.

In a third aspect of the present disclosure, there is provided a computer program product. The computer program product is tangibly stored on a non-transitory computer readable medium and comprises machine executable instructions. The machine executable instructions, when executed, cause a machine to obtain a popularity level of a product and values of a plurality of attributes associated with the product; determine a plurality of influence factors of the plurality of attributes on the popularity level of the product by applying the popularity level and the values of the plurality of attributes to a data processing model; and determine, based on the plurality of influence factors, to adjust at least one attribute of the plurality of attributes to increase the popularity level of the product.

It should be appreciated that the Summary is not intended to identify key or essential features of the embodiments of the present disclosure, or limit the scope of the present disclosure. Other features of the present disclosure will be understood more easily through the following description.

### BRIEF DESCRIPTION OF THE DRAWINGS

Through the following detailed description with reference to the accompanying drawings, the above and other objectives, features, and advantages of the present disclosure will become more apparent. In the drawings, some embodiments of the present disclosure are depicted as examples, without suggesting any limitation.

FIG. 1 illustrates a schematic diagram of an example information processing environment where embodiments of the present disclosure can be implemented.

FIG. 2 illustrates a flowchart of an example method of information processing according to embodiments of the present disclosure.

FIG. 3 illustrates an example causal structure output by a data processing model according to embodiments of the present disclosure.

FIG. 4 illustrates a flowchart of an example process of obtaining values of attributes in a first attribute set according to embodiments of the present disclosure.

FIG. 5 illustrates a flowchart of an example process of obtaining values of a plurality of attributes associated with a product according to embodiments of the present disclosure.

FIG. 6 illustrates a flowchart of an example process of determining to adjust at least one attribute according to embodiments of the present disclosure.

FIG. 7 illustrates example attributes ranked in terms of influence on a popularity level of a product according to embodiments of the present disclosure.

FIG. 8 illustrates example product popularity levels under different product supply intensity according to embodiments of the present disclosure.

FIG. 9 illustrates example product popularity levels under different place coverage rates in a northern division according to embodiments of the present disclosure.

FIG. 10 illustrates an example area coverage rate in a corresponding month after products have been supplied, according to embodiments of the present disclosure.

FIG. 11 illustrates example total numbers of places and example average place magnitudes in four divisions according to embodiments of the present disclosure.

FIG. 12 illustrates a schematic block diagram of a device that can be used to implement embodiments of the present disclosure.

Throughout the drawings, the same or similar reference symbols refer to the same or similar components.

### DETAILED DESCRIPTION OF EMBODIMENTS

Principles and spirits of the present disclosure will be described with reference to several example embodiments illustrated in the drawings. It should be appreciated that description of these embodiments is merely to enable those skilled in the art to better understand and further implement the present disclosure and is not intended for limiting the scope disclosed herein in any manner. In the following description and the appended claims, unless the context clearly indicates otherwise, all the technological and scientific terms have the common meanings as would be understood by those skilled in the art.

As aforementioned, a popularity level of a product may refer to a popularity degree of the product among all possible users, which can embody the penetration of the product, user's satisfaction with the product, competitiveness of the product, the ranking position of the supplier of the product in the industry, and the like. As used herein, a “popularity level” of a product may refer to a popularity rate of the product, which may be represented by a ratio of a number of actual users to all possible users of the product. Besides, a “popularity level” of a product may refer to an index of the product, such as market occupancy (i.e., market share). More generally, a “popularity level” of a product may refer to any index or parameter which can reflect an application level of the product within a certain range (e.g. a group, country, district, industry, market, and the like).

Typically, it is the eternal pursuit of a product supplier to increase a popularity level of its product. More specifically, a supplier of a product (in particular, a new product) probably needs to learn main factors influencing the popularity level of the product and then adjust those factors to increase the popularity level of the product. For example, in order to increase a market share of new toothpaste, the toothpaste supplier probably needs to learn key factors influencing the market share of the new toothpaste, and then improve the corresponding product design and strategy related to the new toothpaste. However, the traditional solutions suffer from failure in effectively determining factors influencing a popularity level of a product.

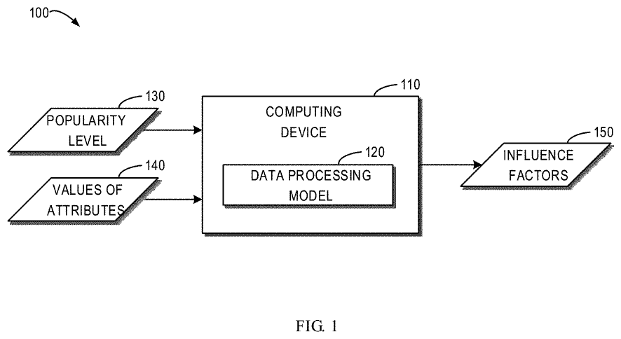

In view of the above and other potential problems in the traditional solutions, the embodiments of the present disclosure provide a method of information processing, electronic device, and computer program product, so as to increase a popularity level of a product. The main conception includes automatically analyzing, based on data associated with a product, a causal structure and key factors influencing a popularity level of a product, and then developing a design and strategy related to the product, so as to increase the popularity level of the product. As compared with the traditional solutions, the solution according to embodiments of the present disclosure can accomplish the goals of automatically learning at least one attribute associated with a product and significantly influencing the popularity level for the product, and then adjusting the at least one attribute to increase the popularity level of the product. In a word, under the guidance of the embodiments of the present disclosure, a supplier of a product can effectively increase the popularity level of the product. Hereinafter, reference will be made to FIGS. 1-11 to describe in detail some embodiments of the present disclosure.

FIG. 1 illustrates a schematic diagram of an example information processing environment 100 where the embodiments of the present disclosure can be implemented. As shown, the information processing environment 100 may include a computing device 110 where a data processing model 120 may be implemented or operated. In some embodiments, the computing device 110 may include any device that can implement a computing and/or control function, including, but not limited to, a dedicated computer, general computer, general processor, microprocessor, microcontroller, or state machine. The computing device 110 may be implemented as an individual computing device or a combination of computing devices, such as a combination of a Digital Signal Processor (DSP) and a microprocessor, a plurality of microprocessors, one or more microprocessors combined with a DSP core, or any other configurations. In addition, the computing device 110 may also be referred to as electronic device 110, and the two terms can be used interchangeable herein.

In some embodiments, a data processing model 120 may include a causal model, such as a Structural Causal Model (SCM). The structural causal model is used in combination with a Structural Equation Model (SEM), Rubin Causal Model (RCM), and probabilistic graphical model (mainly a Bayesian network), and is applied for causal analysis. Using a causal model, the data processing model 120 can improve an accuracy of a determined influence factor of a characteristic variable on a target variable. In other embodiments, the data processing model 120 may include any algorithm or model capable of computing an influence factor of a characteristic variable on a target variable, such as various machine learning models, and the like. More generally, the data processing model 120 may be any model having a data processing ability.

According to embodiments of the present disclosure, in order to increase a popularity level of a product (e.g. a new product), the popularity level 130 (e.g. the popularity level computed monthly) of the product and values 140 of a plurality of attributes associated with the product can be supplied to the computing device 110. Then, the computing device 110 can determine, using a data processing model 120, influence factors (i.e., influence weight, or influence significance) 150 of the plurality of attributes being input on the popularity level 130. Based on the influence factors of the plurality of attributes on the popularity level 130 of the product, the computing device 110 can selectively adjust at least one attribute from the plurality of attributes, to increase the popularity level 130 of the product. For ease of description, a product to which the computing device 110 is directed to increase the popularity level thereof will be referred to as “present product” or “target product.”

In some embodiments, communication links between respective components in the example information processing environment 100 may be connection or coupling in any form that can achieve data communication or control signal communication between those components, including, but not limited to, coaxial cables, optic fiber cables, twisted-pair cables, or wireless technologies (e.g. infrared, radio and microwave). In some embodiments, the communication links may include, but not limited to, devices for network connection (e.g. a network card, hub, modem, repeater, bridge, switch, router, and the like), as well as various network connection lines, wireless links, and the like. In some embodiments, communication links may include various types of buses. In other embodiments, the communication links may include a computer network, communication network, or other wired or wireless network.

It should be appreciated that FIG. 1 only schematically shows units, modules or components related to the embodiments of the present disclosure in the example information environment 100. In practice, the example information processing environment 100 my further include other units, modules or components of other functions. Moreover, the specified number of units, modules or components as shown in FIG. 1 is provided only as an example, without suggesting any limitation to the scope of the present disclosure. In other embodiments, the example information processing environment 100 may include any appropriate number of computing devices, data processing models, and the like. Therefore, the embodiments of the present disclosure are generally applied to any computing-device based information processing environment, rather than restricted to specific devices, units, modules, or components as depicted in FIG. 1.

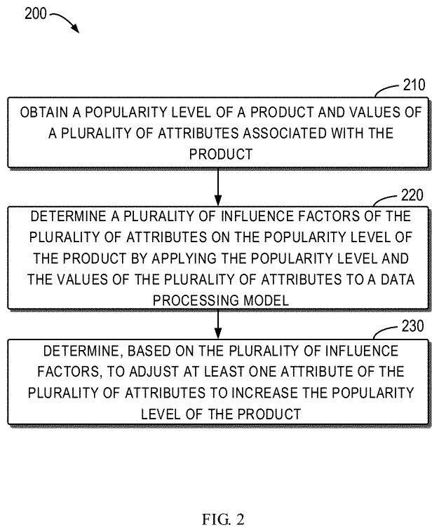

FIG. 2 illustrates a flowchart of an example method of information processing 200 according to embodiments of the present disclosure. In some embodiments, the method 200 may be implemented by a computing device 110 in an information processing environment 100, for example, a processor or processing unit of the computing device 110, or various functional modules of the computing device 100. In other embodiments, the method 200 may be implemented by a computing device independent of the information processing environment 100, or other unit or module in the information processing environment 100. For ease of discussion, the method 200 will be described below with reference to FIG. 1.

At 210, the computing device 110 may obtain a popularity level 130 of a product and values 140 of a plurality of attributes associated with the product. In some embodiments, data related to the popularity level 130 can be supplied to the computing device 110 in the form of sampled values over a certain period. For example, the computing device 110 may obtain an annual, monthly or daily popularity level of the product. Any other time periods for sampling or aggregating of the popularity level are also feasible. In other embodiments, data related to the popularity level 130 can also be supplied to the computing device 110 in any other appropriate form.

In addition, in order to analyze the main or key factors influencing a popularity level 130, the computing device 110 may obtain values 140 of a plurality of attributes associated with a product to be analyzed, to determine attributes of the plurality of attributes significantly influencing the popularity level 130. As used herein, attributes associated with a product may refer to any properties or characteristics of the product per se probably influencing a popularity level 130, or any properties or characteristics of an environment or various strategies associated with the product.

As used herein, the values 140 of the attributes may be represented in any appropriate data form, and a specific data form may be determined by a manner of describing the attributes. As an example, the values 140 of the attributes may include continuous numerical values. For instance, attributes such as user cost, an amount of supply, and the like, can be represented by continuous numerical values. As a further example, the values 140 of the attributes may include discontinuous values. For instance, the attribute “the product has a mint flavor or not” can be valued only in two ways while the attribute “the season when the product is first supplied” can be valued in four ways. In other circumstances, the values 140 of the attributes can also be in the form of text for describing the attributes. For example, “the northern area” in the attribute “an amount of supply of the product in the northern area” can be represented in the form of text. In this way, the computing device 110 can process the attribute values or content in the form of text, and convert the form into numerical values or Boolean values for further processing.

In some embodiments, the values 140 of those attributes related to the product may be obtained by sampling, aggregating or computing the data related to the product, and then input into the computing device 110. In other embodiments, instead of being supplied with the popularity level 130 and the values 140 of the plurality of attributes of the product from a user or other device, the computing device 110 can automatically identify and capture those data from a database or Internet data resource where the above-mentioned data are stored thereon. For example, the computing device 100 may monitor those data in the database or Internet data resource regularly or in real time. Accordingly, upon detecting that the popularity level 130 and the values 140 of the plurality of attributes of the product have been generated or stored, the computing device 110 can automatically obtain the data. It should be pointed out here that, if the following description mentions that the computing 110 obtains data or information, it is to be read as that the computing device 100 can receive the data or information from a user or other device, or can automatically obtain the data or information from a location where the data or information is stored.

Moreover, it should be noted that attributes associated with the product potentially influencing the popularity level 130 may be sourced from multiple aspects. For instance, as an example of attributes in one aspect, a competitive environment (e.g., market environment) of the product probably influences the popularity level 130. Generally speaking, a fierce competitive environment of a product indicates competing products of the product having strong competitiveness, and the popularity level 130 of the present product thus is probably low. In turn, a less competitive environment of a product indicates competing products of the product having weak competitiveness, and the popularity level 130 of the present product thus is probably high. In addition to competing products of the present product, attributes of other products associated with the present product (e.g., related product supplied together with the present product, and the like) may also influence the popularity level 130 of the present product.

Consequently, in some embodiments, when obtaining the values 140 of the plurality of attributes associated with the product, the computing device 110 may obtain values of attributes in a first attribute set associated with a plurality of related products (also referred to as first products, for example, competing products) associated with the product, to facilitate description of a competition environment in which the product is located and other product environment. In this way, factors related to the competition environment in which the product is located can be taken into account when analyzing key factors influencing the popularity level 130. For example, if the computing device 100 concludes, from subsequent analysis, that influence factors of a competing product on the present product are of great values, the design, user cost strategy, and supply strategy of the present product should be made or formulated with reference to the competing product, to effectively increase the popularity level 130 of the present product.

It is worth noting that competing products will be taken as an example of related or first products below to describe some embodiments of the present disclosure. However, it should be appreciated that the embodiments of the present disclosure equally cover any other related or first products of the present product, rather than being limited to the competing products as described herein.

More specifically, the computing device 110 can obtain data of a plurality of competing products related to an amount of supply, user cost, a popularity level, and the like, which are considered as values of attributes in the first attribute set as mentioned above. In other words, amount of supply, user cost, and popularity levels of various competing products related to the present product may influence the popularity level of the present product, and thus can be supplied to the computing device 110, as values 140 of a plurality of attributes associated with the present product.

It should be appreciated that a plurality of competing products of the present product may be different from one another, where one of the competing products may have the same values as the present product with regard to some characteristics, another one may have the same values as the present product with regard to some other characteristics, and a further one may have the same values as the present product with regard to a majority of characteristics. That is, different competing products may have different similarities to the present product, or may be identical to the present product with regard to different characteristics.

As used herein, a “characteristic” may refer to unique property of a product. More generally, a characteristic of a product may refer to any property or characteristic of the product. For example, if the product is toothpaste, the characteristics may cover capacity, package, effect, flavor, medicinal purpose, brand, and the like. It should be appreciated that, if the product is other article (instead of toothpaste) or a service, the product may cover other appropriate characteristics.

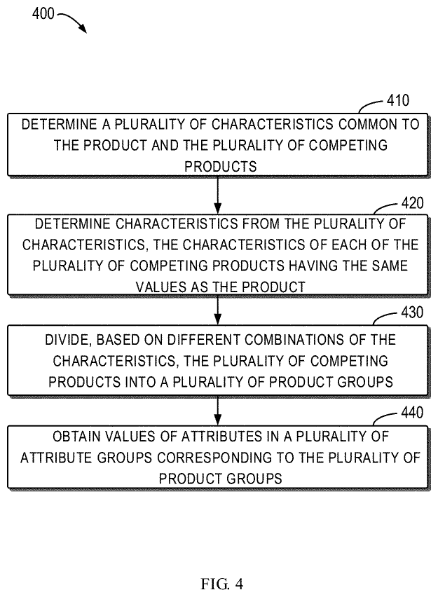

As a result, in some embodiments, in order to accurately analyze influence factors of attributes associated with different competing products on the popularity level 130 of the present product, the computing device 110 may divide a plurality of competing products into a plurality of competing product groups, based on which characteristics of the competing products are the same as those of the present product and then determine values of attributes associated with the present product for each competing product group. Such example will be described below in detail with reference to FIG. 4.

As an example of attributes in another aspect, a user cost (e.g., product pricing) strategy of a product may influence the popularity level 130 of the product. In the context, “user cost” of a product may refer to cost or a price that a user needs to spend for the use of the product, for example, a price required to be paid by a user for the product. In general, if a product has high user cost (which indicates a high cost required if a user desires to obtain the product), the product probably has a low popularity level 130. On the contrary, if a product has low user cost (which indicates a low cost required if a user desires to obtain the product), the product probably has a high popularity level 130.

Accordingly, in some embodiments, when obtaining the values 140 of the plurality of attributes associated with the product, the computing device 110 may obtain values of attributes in a second attribute set associated with a user cost strategy of the product, to describe the user cost strategy (e.g. a pricing strategy) of the product. In this way, factors related to the user cost strategy of the product may be taken into account when analyzing key factors influencing the product popularity level 130. For example, attributes related to the user cost probably influencing the popularity level 130 of the product may be analyzed and then adjusted when determined as having significant influence on the product popularity level 130, to improve the popularity level 130 of the present product.

More specifically, attributes in the second attribute set may include an average user cost over a period (e.g., a month, a specific month when a new product started to be supplied, and the like). Alternatively or in addition, attributes in the second attribute set may cover a ratio of an average user cost of the product to an average user cost of peer products of a plurality of competing products. As such, absolute user cost of the present product and relative user cost of the peer products can be analyzed, and the attributes then can be adjusted when determined as having significant influence on the popularity level 130, so as to effectively increase the popularity level 130. It is worth noting that both the product and the competitive products may have a plurality of characteristics, and the plurality of characteristics of the peer products thus may have the same values as the present product.

In another example, attributes in the second attribute set may include any one or combination of user cost elasticity of the present product, user cost elasticity considering time delay, relative user cost elasticity, relative user cost elasticity considering time delay, maximum fluctuation value of user cost, relative maximum fluctuation value of user cost, an average user cost fluctuation value, a relative average fluctuation value of user cost, an adjustment frequency of user cost, a user cost difference, and a relative user cost difference. In this way, various statistical attributes related to the user cost of the present product can be analyzed and then adjusted when determined as having significant influence on the popularity level 130, so as to effectively increase the popularity level of the present product.

Among the attributes mentioned above, user cost elasticity may represent a difference between an average price of the present product in a month Y and an average price in a month X. User cost elasticity considering time delay may represent a difference between an average price in the last two weeks after the month Y and the average price in the month X. Relative user cost elasticity may be obtained by dividing, by the average price in the month X, the difference between the average price of the present product in the month Y and the average price in the month X. Relative user cost elasticity considering time delay may be obtained by dividing, by the average price in the month X, the difference between an average price in the last two weeks after the month Y and the average price in the month X, where X and Y are both integers, and Y>X.

A maximum fluctuation value of user cost may represent a difference between a maximum and a minimum price of the present product from the month X to the month Y. A relative maximum fluctuation value of user cost may be obtained by dividing, by the average price in the month X, the difference between the maximum and the minimum price of the present product from the month X to the month Y. An average fluctuation value of user cost may be obtained by dividing a sum of average price differences of multiple adjacent months by the number of months. A relative average fluctuation value of user cost may be obtained by dividing the average user cost fluctuation value by an average price in a certain month. An adjustment frequency of user cost may represent a count of price changes from the month X to the month Y. A user cost difference may represent a difference between a price of the present product after it has been supplied and a price supplied in a first month. A relative user cost difference may be obtained by dividing the user cost difference by an average price in a certain month. It should be appreciated that the month as used herein is a statistical period, which is provided as an example, without suggesting any limitation to the scope of the present disclosure. In other embodiments, the above attributes may be obtained over any period.

As an example of attributes in a further aspect, a supply strategy (e.g., a delivery strategy) of a product may influence a popularity level 130 of the product. Generally speaking, if an amount of supply or scope of supply of a product is small (which indicates a small possibility for a user to obtain the product), the product probably has a low popularity level 130. Instead, if the amount of supply or scope of supply of a product is large (which indicates a high possibility for a user to obtain the product), the product probably has a high popularity level 130.

In view of the above, in some embodiments, when obtaining values 140 of a plurality attributes associated with a product, the computing device 110 may obtain values of attributes in a third attribute set associated with a supply strategy of the product, to describe the supply strategy of the product. In this way, factors related to the supply strategy of the product may be taken into account when analyzing key factors influencing the popularity level 130. For example, attributes related to the supply strategy probably influencing the popularity level 130 may be analyzed and then adjusted when determined as having significant influence on the popularity level 130, so as to effectively increase the popularity level of the product.

In some embodiments, attributes in the third attribute set may include any one or combination of the following attributes: a season when the present product is first supplied, a ratio of a number of places (e.g. shops) where the product is supplied to a total number of places in a geographical area (e.g., a whole administrative area such as a country) including a plurality of geographical divisions (e.g., the eastern, southern, western, and northern), a ratio of a number of places where the product is supplied to a total number of places in each of the plurality of geographical divisions, a number of geographical divisions where the product is supplied, an average magnitude of a place where the product is supplied in each of the plurality of geographical divisions, and other similar attributes. In this way, various statistical attributes related to a supply strategy can be analyzed and then adjusted when determined as having significant influence on the popularity level 130, so as to effectively increase the popularity level of the present product.

It should be noted that, in some embodiments, values of attributes with regard to the above-mentioned aspects may be directly obtained by sampling or aggregating. For example, a user of the computing device 110 may predetermine a plurality of attributes associated with a product to be input into the computing device, and then the user of the computing device 110 (or the computing device 110 per se) can record values of the plurality of attributes associated with the product during a period. Thereafter, the user of the computing device 110 may supply the sampled or aggregated values of the attributes to the computing device 110. However, given the fact that a number of attributes corresponding to attribute values supplied to the computing device 100 typically reaches tens or even hundreds, it is tedious or impossible if the values of the attributes are recorded by the user one by one, and it wastes resources if the recording is performed by the computing device 110.

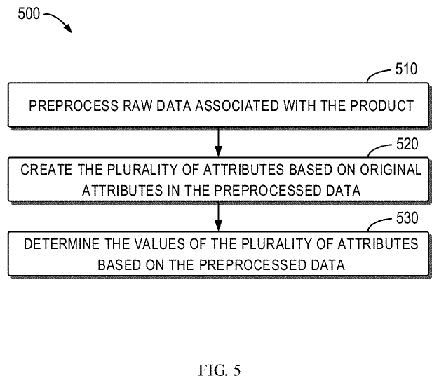

In order to avoid the unfavorable situations, in some embodiments, the user may provide the computing device 110 with raw data associated with the present product, for example, an amount of supply, user cost and popularity levels of competing products, an amount of supply and user cost of the present product, and the like. Then, based on the raw data, the computing device 110 may create or generate more attributes and then determine values of the created attributes, without the necessity for the user or computing device 110 to record the values of the attributes one by one. Such example will be described below with reference to FIG. 5.

Still referring to FIG. 2, at 220, after obtaining a popularity level 130 of a product and values 140 of a plurality of attributes, the computing device 110 may apply them to the data processing model 120 to determine a plurality of influence factors of the plurality of attributes on the popularity level 130. For example, the computing device 110 may input related data of the popularity level 130 of the product into the data processing model and specify them as target variables. In addition, the computing device 110 may input the values of the plurality of attributes associated with the product into the data processing model 120 and specify them as characteristic variables.

After computing, the data processing model 120 may output an influence factor of each attribute of the plurality of attributes on the popularity level 130, namely the magnitude of influence. It is worth noting that the influence factor as used here may be an absolute influence factor of the each attribute on the popularity level 130, or a relative influence magnitude relative to other attributes. In other words, in some embodiments, the computing device 110 may provide relative influence magnitude of the plurality attributes on the popularity level 130, to indicate which attributes have more influence on the popularity level 130, and which attributes have less influence on the popularity level 130, without giving the specific numerical values of the influence factors.

In some embodiments, the computing device 110 may implement or run the data processing model 120 by implementing a causal structure learning module. In those embodiments, the causal structure learning module of the computing device 110 may learn, based on all the input attributes associated with the product, a causal structure between those attributes and the popularity level 130 using a causal structure learning technology, and obtain, based on learning of the causal structure, key factors influencing the popularity level 130.

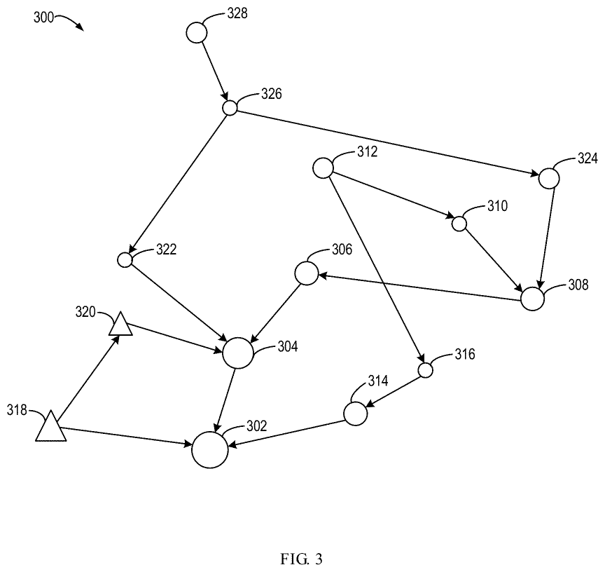

It should be appreciated that the data processing model 120 may output the influence factors of the plurality of attributes on the popularity level 130 in any appropriate manner. For example, the data processing model 120 may sequentially list the influence factor of each attribute (e.g. from the big to the small) in a list form. For another example, the data processing model 120 may demonstrate a magnitude of the influence factor of each attribute in the form of histogram. In some embodiments, the data processing model may display the influence factors of the plurality of attributes on the popularity level 130 in a graph of causal structure. Such examples will be described below with reference to FIG. 3.

FIG. 3 illustrates an example causal structure 300 output by the data processing model 120 according to embodiments of the present disclosure. In the causal structure 300, the circle 302 at the bottom represents a popularity level 130 as a target. The circles 304, 306, 308, 312, 314, 324 and 328 represent key factors having continuous values, namely attributes with continuous values having significant influence on the popularity level 130.

The circles 310, 316, 322 and 326 represent usual factors having continuous values, namely attributes with continuous values having less influence on the popularity level. The triangle 318 denotes a two-valued key factor, namely a two-valued attribute having significant influence on the popularity level 130. The triangle 320 indicates a two-valued usual factor, namely a two-valued attribute having less influence on the popularity level 130.

In addition, the arrow in the causal structure 300 represents a causal effect, namely a causal effect of an attribute on another one. For example, the arrow pointing from the circle 306 to the circle 304 represents that a change of the attribute represented by the circle 306 may result in a change of the attribute represented by the circle 304. As a result, a user of the data processing model 120 can intuitively observe how a certain attribute influences the ultimate target 302. For example, the attribute 308 influences the attribute 306, further the attribute 304, and ultimately the target 302. For example, the attributes 304, 314 and 318 all directly influence the target 302.

Furthermore, areas of various graphics in the causal structure 300 can intuitively embody magnitudes of the influence factors of the attributes on the popularity level 130 which is the target 302, such that a user of the data processing model 120 can intuitively observe whether a certain attribute is a key or usual attribute with regard to the target 302. For example, it can be seen intuitively from the causal structure 300 that the influence of the attribute 304 on the target 302 is more significant than that of the attribute 306, and the influence of the attribute 306 on the target 302 is more significant than that of the attribute 316.

Back to FIG. 2, at 230, based on the plurality of influence factors of the plurality attributes associated with the product on the popularity level 130, the computing device 110 may determine at least one of the plurality of attributes, to increase the popularity level 130 of the product. For example, the computing device 110 may output an attribute adjustment strategy or adjustment suggestion to a user or other devices, where at least one attribute needing adjustment as determined by the computing device 110 is specified. In some embodiments, the computing device 110 may determine to adjust an attribute having the greatest influence factor on the popularity level 130, to increase the popularity level 130. In this way, the solution can effectively increase the popularity level 130 when the characteristics of the product or the strategy are changed the least.

For example, it is assumed that the attribute having the greatest influence factor on the popularity level 130 is an attribute of the third attribute set as described above, namely supply intensity of the product over a period (i.e., a ratio of a number of places (e.g. shops) supplying the present product to a total number of places). In this way, the computing device 110 may determine to increase the supply intensity of the product over a period, to increase the popularity level 130 of the product.

For another example, it is assumed that the attribute has the maximum influence factor on the popularity level 130 is an attribute of the third attribute set as described above, namely a place coverage rate of the product in a northern area (also referred as division) (i.e., a ratio of a number of places (e.g. shops) where the present product is supplied to a total number of places). In this way, the computing device 110 may determine to increase the place coverage rate of the product in the northern area, to increase the popularity level 130 of the product.

For a further example, it is assumed that the attribute has the greatest influence factor on the popularity level 130 is an attribute of the first attribute set as described above, namely a popularity level of a competing product different than the present product in capacity characteristic and package characteristic. In this way, when designing the present product, the computing device 110 may determine to keep the present product consistent with a competing product with the same brand (which is also one of the characteristics) having a higher popularity level in terms of flavor, effect, medicinal function, and the like, so as to increase the popularity level 130 of the product.

In a still further example, it is assumed that the attribute has the greatest influence factor on the popularity level 130 is another attribute of the first attribute set as described above, namely a number of competing products different than the present product in terms of band characteristic, package characteristic, effect characteristic, and medicinal characteristic. In this way, when designing the present product, the computing device 110 may determine to take into account information of products different than the subject patent in band (which is also one of the characteristics) and make the present product distinguished from products of other bands as much as possible, for example, distinguished from most of the products incomparable with the present product in terms of flavor characteristic, medicinal characteristic, and package characteristic, so as to increase the popularity level 130 of the product.

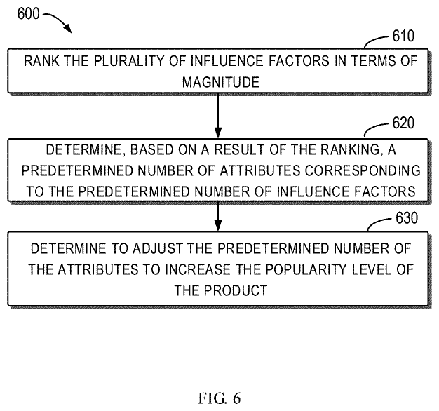

In other embodiments, the computing device 110 may determine to adjust a plurality of attributes having larger influence factors on the popularity level 130, so as to increase the popularity level 130 of the product to a greater extent. Such examples will be described below with reference to FIG. 6.

In some embodiments, the computing device 110 may determine to adjust at least one of the plurality of attributes by obtaining a strategy suggestion module. In those embodiments, the strategy suggestion module of the computing device 110 may formulate different strategy suggestions, based on the obtained key factors influencing the popularity level 130, and further provide them to the product supplier, so as to increase the popularity level 130 of the product.

As mentioned in the description about block 210 of FIG. 2, in some embodiments, in order to more accurately analyze influence factors of attributes associated with different competing products on the popularity level 130 of the present product, the computing device 110 may divide a plurality of competing products of the present product into a plurality of competing product groups based on which characteristics of the competing products are the same as those of the present product, and then determine values of attributes associated with the product for each competing product group. Reference now will be made to FIG. 4 to describe such an example.

FIG. 4 illustrates a flowchart of an example process of obtaining values of attributes in the first attribute set according to embodiments of the present disclosure. In some embodiments, the process 400 may be implemented by a computing device 110 in an information processing environment 100, for example, a processor or processing unit of the computing device 110, or various functional modules of the computing device 100. In other embodiments, the process 400 may be implemented by a computing device independent of the information processing environment, or other units or modules in the information processing environment 100. For ease of discussion, the process 400 will be described below with reference to FIG. 1.

At block 410, the computing device 110 may determine a plurality of common characteristics common to the present product and a plurality of competing products. As described above, “characteristic” is different than “attribute,” which may refer to unique property of a product. More generally, a characteristic of a product may refer to any property or characteristic of the product. For example, if the product is toothpaste, the characteristics may include capacity, package, effect, flavor, medicinal purpose, brand, and the like. It should be appreciated that, if the product is other article (instead of toothpaste), or a service, the product may have other appropriate characteristics.

In general, both a present product and competing products may have a plurality of common characteristics, i.e., both the present product and the competing products have those characteristics. Toothpaste is still taken as an example herein. The computing device 110 may determine that both the present product and the competing products have common characteristics such as capacity, package, effect, flavor, medicinal purpose, brand, and the like. That is, those characteristics are common to the present product and the competing products. It should be appreciated that the characteristics listed above are provided only as an example, without suggesting any limitation to the scope of the present disclosure. In other embodiments, a plurality of common characteristics common to a present product and a plurality of competing products may include any other characteristics.

At 420, the computing device may determine, from a plurality of common characteristics common to the present product and the competing products, characteristics of each competing product of the plurality of competing products having the same values as the present product. For example, in the embodiments where the present product is toothpaste, the capacity of the present product may be valued as 150g, the package may be valued as individually packaged, the effect may be valued as whitening, the flavor may be valued as mint, the medicinal function may be valued as diminishing inflammation, and the brand may be valued as Brand A.

Accordingly, for example, if the competing product is weighted 150g and individually packaged, the computing device 110 may determine that characteristics of the competing product having the same values as present product include capacity and package. Likewise, for example, if the competing product is a product with Brand A, weighted 150g and individually packaged, the computing device 110 may determine that characteristics of another competing product having the same values as present product include capacity, effect and brand. As such, the computing device 110 can determine characteristics of each competing product having the same values as the present product. Moreover, there is a possibility that values of all characteristic of a competing product taken into consideration are fully identical to or different than those of the present product.

At 430, the computing device 110 may divide the plurality of competing products into a plurality of product groups, based on different combinations of characteristics of the competing products having the same values as the present product. For example, if the above present product has 6 characteristics, competing products can be divided into 64 competing product groups, including: a competing product group having no characteristic with the same value as the present product, a competing product group having only one characteristic with the same value as the present product, a competing product having two characteristics with the same values as the present product . . . a competing product group having six characteristics with the same values as the present product. It should be appreciated that the specific number of characteristics and competing product groups are provided only as an example, without suggestion any limitation to the scope of the present disclosure, and the embodiments of the present disclosure can equally cover any number of characteristics and competing product groups.

At 440, the computing device 110 may obtain values of attributes in a plurality of attribute groups corresponding to a plurality of competing product groups. For example, when the competing products are divided into 64 competing product groups, the computing device 110 may obtain 64 attribute groups each corresponding to a competing product group. Each attribute group may include attributes of a plurality of competing products in a respective competing product group probably influencing the popularity level 130 of the present product.

For example, each attribute group may include one or any combination of the following: a number of competing products in a competing product group of the plurality of competing product groups, an average user cost, and an average popularity level. In other words, those attributes of competing products may influence the popularity level 130 of the present product. As such, the attributes of the competing product significantly influencing the popularity level 130 may be supplied to the computing device 110 for analysis, such that the computing device 110 can compute attributes influencing more significantly on the popularity level 130 in the follow-up.

Moreover, the values of the attributes in the first attribute set obtained using the example process 400 can be supplied to the computing device 110 for analysis, based on the influence of the related attributes of the competing product groups on the popularity level 130 of the present product, which are divided based on the different combinations of characteristics of the competing products having the same values as the present product. Thereupon, the computing device 110 can guide the supplier of the present product to adjust specific characteristics of the present product with reference to the competing product group significantly influencing the popularity level 130 of the present product, to more effectively increase the popularity level 130.

As mentioned above in the description about block 210 of FIG. 2, in some embodiments, a user of the computing device 110 may provide the computing device 110 with raw data associated with the present product, such as an amount of supply, user cost and popularity level of competing products, an amount of supply and user cost of the present product, and the like. Subsequently, based on the raw data, the computing device 110 may create or generate more attributes and then determine values of the created attributes, without the necessity for the user or computing device 110 to record the values of the attributes one by one. Such example will be described now with reference to FIG. 5.

FIG. 5 illustrates a flowchart of an example process of obtaining values of a plurality of attributes associated with a product according to embodiments of the present disclosure. In some embodiments, the process 500 may be implemented by a computing device 110 in an information processing environment 100, for example, a processor or processing unit of the computing device 110, or various functional modules of the computing device 100. In other embodiments, the process 500 may be implemented by a computing device independent of the information processing environment, or other units or modules in the information processing environment 100. For ease of discussion, the process 500 will be described below with reference to FIG. 1.

At 510, the computing device 110 may preprocess raw data associated with a product. In some embodiments, the computing device 110 may process text information in the raw data. More specifically, the computing device 110 may process attribute information of the product. For example, the computing device 110 may convert obtained new characteristic based on possible values of the product in terms of certain characteristic, to indicate whether the product has the aforementioned value. For example, suppose that possible values of a present product in terms of flavor characteristic include mint, fruit, and tea, this characteristic can be converted into three characteristics as follows: whether the present product has a mint flavor or not, whether the present product has a fruit flavor or not, and whether the present product has a tea flavor or not.

Moreover, the computing device 110 may de-noise raw data (i.e., remove invalid samples). For examples, if a target variable is a popularity level of a present product in a month of a stable supply period, the computing device 110 may compute the popularity level in the month for all samples of the present product in the raw data, and remove noise samples where the target variable is empty (i.e., the popularity level records of the present product in respective months are missing for some reasons).

In some embodiments, the computing device may preprocess the raw data by implementing a data preprocessing module. In those embodiments, the data preprocessing module of the computing device 110 may de-noise the raw data and process text information in the raw data.

At 520, the computing device 110 may create a plurality of attributes based on original attributes in the preprocessed raw data. For example, the original attributes in the preprocessed raw data may include data on the amount of supply, user cost data, popularity level data, and the like, of a plurality of competing products. In this way, the computing device 110 may divide the plurality of competing products into a plurality of competing product groups, and then create a plurality of attributes for each competing product group, such as a number of competing products in the competing product group, an average user cost, an average popularity level, and the like.

In another example, the original attributes in the preprocessed raw data may include an average user cost of the present product per month. In this way, the computing device 110 may create, based on the average user cost of the present product per month, the plurality of attributes as described above, including: user cost elasticity of the present product, user cost elasticity considering time delay, relative user cost elasticity, relative user cost elasticity considering time delay, maximum fluctuation value of user cost, relative maximum fluctuation value of user cost, an average fluctuation value of user cost, a relative average fluctuation value of user cost, an adjustment frequency of user cost, a user cost difference, a relative user cost difference, and the like.

In a further example, the original attributes in the preprocessed raw data may include specific places where the present product is supplied, and an amount of supply in each place. In this way, by dividing the places into geographical divisions (e.g., the eastern, southern, western, and northern), the computing device 110 may create the plurality of attributes as described above, including: a ratio of a number of places where the product is supplied to a total number of places in a geographical area including a plurality of geographic divisions, a ratio of a number of places where the product is supplied to a total number of places in each of the plurality of geographical divisions, a number of the geographical divisions where the product is supplied, and the like.

At 530, after creating a plurality of new attributes from the original attributes, the computing device 110 may determine values of the plurality of attributes based on the preprocessed raw data. For example, the computing device 110 may compute, based on the raw data, a number of competing products in a competing product group, an average user costs, an average popularity level, and the like; compute user cost elasticity, user cost elasticity considering time delay, relative user cost elasticity, relative user cost elasticity considering time delay, maximum fluctuation value of user cost, relative maximum fluctuation value of user cost, an average fluctuation value of user cost, a relative average fluctuation value of user cost, an adjustment frequency of user cost, a user cost difference, a relative user cost difference, and the like; and compute a ratio of a number of places where the product is supplied to a total number of places in a geographical area including a plurality of geographic divisions, a ratio of a number of places where the product is supplied to a total number of places in each of the plurality of geographical divisions, a number of the geographical divisions where the product is supplied, and the like.

In some embodiments, the computing device 110 may implement the example process 500 by implementing a feature engineering module. In those embodiments, the feature engineering module may devise or generate new features (i.e., new attributes), based on existing features (i.e., attributes) in the raw data, for subsequent causal learning of the causal structure learning module (or data processing model 120). For example, the feature engineering module of the computing device may devise or generate new features related to competing products of the present product, to describe a competitive environment of the present product; devise or generate new features related to the user cost of the present product, to describe user cost strategy information of the present product; and devise or generate new feature related to the supply of the present product, to describe supply strategy of the present product.

Based on the values of the plurality of attributes obtained using the example process 500, the computing device 110 may generate or create various new attributes from raw data of the present product and the competing products, for subsequent influence factor analysis, and adjust the attributes when determining them as significantly influencing the popularity level 130 of the present product, to effectively increase the popularity level. Furthermore, the example process 500 causes the user or computing device 110 to be free from recording the values of the created attributes one by one, thereby reducing the loads of the user or computing device 110, improving the user experience, and saving the processing resources.

As mentioned in the description about block 210 in FIG. 2, in some embodiments, the computing device 110 can determine to adjust a plurality of attributes having large influence factors on the popularity level 130 of the product, to increase the popularity level 130 to a greater extent. Such example will now be described with reference to FIG. 6.

FIG. 6 illustrates a flowchart of an example process 600 of determining to adjust at least one attribute according to embodiments of the present disclosure. In some embodiments, the process 600 may be implemented by a computing device 110 in an information processing environment 100, for example, a processor or processing unit of the computing device 110, or various functional modules of the computing device 100. In other embodiments, the process 600 may be implemented by a computing device independent of the information processing environment, or other units or modules in the information processing environment 100. For ease of discussion, the process 600 will be described below with reference to FIG. 1.

At 610, the computing device 110 may rank a plurality of influence factors in terms of magnitude. For example, in the example of FIG. 3, the computing devices may rank the plurality of influence factors of the plurality of attributes in terms of magnitude in an order of: attribute 304, attribute 306, attribute 308, attribute 314, attribute 316, attribute 318, attribute 324, and attribute 328. In some embodiments, the computing device 110 may generate a bar chart to display the plurality of influence factors and respective attributes thereof ranked in terms of magnitude.

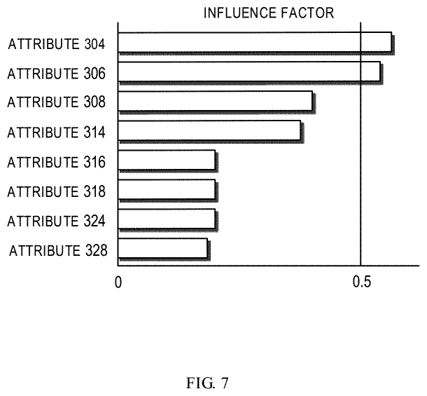

FIG. 7 illustrates ranking example attributes in terms of influence magnitude on a product popularity level 130 according to embodiments of the present disclosure. FIG. 7 further depicts the example of FIG. 3, where only the preceding eight attributes having larger influence factors are listed. That is, a bar chart is generated which displays the preceding eight attributes of influence factors on the target 302 ranked in a descending order in the example causal structure 300 as depicted in FIG. 3.

As shown in FIG. 7, the bars respectively corresponding to the attribute 304, attribute 306, attribute 308, attribute 314, attribute 316, attribute 318, attribute 324, and attribute 328 are displayed sequentially from top to bottom and from long to short. A bar corresponding to each attribute represents an influence magnitude on the target 302. For example, in the example of FIG. 7, the influence factors of the attribute 304 and attribute 306 on target 302 are greater than 0.5 while the influence factors of other attributes on the target 302 are less than 0.5.

It should be appreciated that the specific number of bars, bar length, and value magnitude of influence factors of attributes are provided only as an example, without suggesting any limitation to the scope of the present disclosure. The embodiments of the present disclosure can equally cover any number (e.g., all) of bars, any bar length, and attributes having influence factors with any appropriate values.

Returning to FIG. 6, at 620, the computing device 110 may determine, based on the result of ranking the influence factors, a predetermined number of attributes corresponding to a predetermined influence factors. For example, in the example of FIG. 7, assuming that the predetermined number is three, the computing device 110 may determine, based on a result of ranking in FIG. 7, three attributes corresponding to the preceding three influence factors as the attribute 304, attribute 306 and attribute 308. It should be appreciated that the specific value of the predetermined number is provided only as an example, without suggesting any limitation to the scope of the present disclosure. The embodiments of the present disclosure can equally cover any appropriate predetermined number.

At 630, the computing device 110 may determine to adjust a predetermined number of attributes to increase the popularity level 130 of the product. For example, in the example of FIG. 7, the computing device 110 may determine to adjust three attributes, namely the attribute 304, attribute 306, and attribute 308, to increase the popularity level 130 of the product. It should be noted that, given the fact that the three attributes are three attributes having influence factors on the popularity level 130 ranked in the top, as compared with adjustment of only one attribute, adjustment of the above-mentioned three attributes can achieve a greater promotion of the popularity level 130, without causing too many changes in design or strategy of the present product.

In other words, by using an example process 600 to determine to adjust at least one attribute, the computing device 110 can enable adjustment of one or more attributes in a more flexible and explicit manner and achieve a balance between a promotion of the popularity level 130 and a product change, so as to more effectively increase the popularity level 130 of the product.

In some embodiments, by obtaining a reason insight module, the computing device 110 can verify a causal relationship between attributes supplied by the causal structure learning model (or data processing model 12) and the product popularity level 130 automatically or according to a user indication. In those embodiments, based on the causal structure and the important attributes learnt by the causal structure learning module (or data processing model 120), the reason insight module of the computing device 110 may perform further statistical analysis on the attributes to verify the correctness of the causal.

More specifically, by a local causal structure diagram in FIG. 3, the reason insight module of the computing device 110 may detect all paths of a certain important factor (i.e., attribute) influencing the popularity level 130. For example, it is assumed that, in FIG. 3, the attribute 306 represents a place coverage rate of a present product in a northern division in a month while the attribute 304 represents a supply intensity of the present product in the whole geographical area in a month. As used here, a place coverage rate of a product in a northern division can be obtained by dividing, by a total number of places in the northern division, a number of places in the northern division where the product is supplied, and a supply intensity of the product may be obtained by dividing, by the total number of places, a number of places where the present product is supplied.

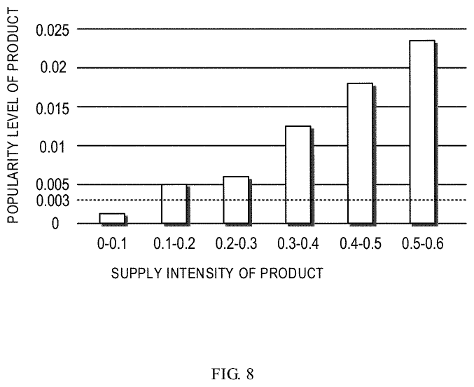

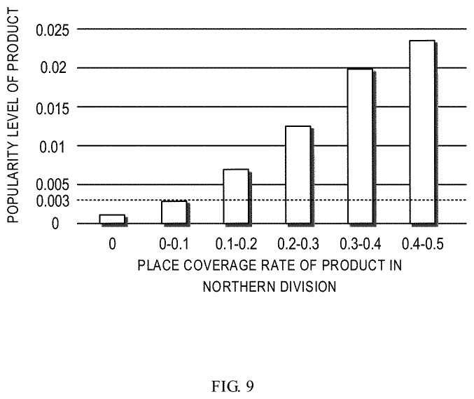

From the local causal structure diagram in FIG. 3 where the attribute 306 points to the attribute 304 and further to the target 302, the reason insight module of the computing device 110 can obtain that: the supply intensity of the present product in the whole geographical area in a month has a causal effect on the product popularity level 130, and the place coverage rate of the present product in the northern area in the month has a causal effect on the supply intensity of the present product in the whole geographical area in the month. Therefore, the reason insight module of the computing device 110 verifies the causal between the attributes supplied by the causal structure learning module (or data processing model 120) and the product popularity level 130 with respect to physical meanings of those attributes. This is further verified in FIGS. 8 and 9.

FIG. 8 illustrates example popularity level 130 under different product supply intensity according to embodiments of the present disclosure. As shown in FIG. 8, the bars corresponding to product supply intensity intervals “0-0.1,” “0.1-0.2,” “0.2-0.3,” “0.3-0.4,” “0.4-0.5,” and “0.5-0.6” indicate popularity level of the product under respective supply intensity. In addition, in the example of FIG. 8, the average popularity level of the product is 0.003 (shown in a dotted line). As can be seen clearly from FIG. 8, the popularity level 130 when the product supply intensity is greater than 0.4 is much higher than the popularity level 130 when the product supply is less than 0.3.

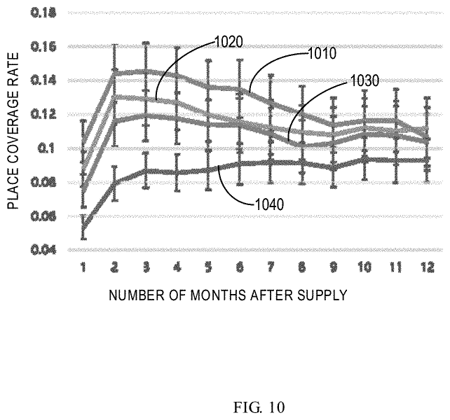

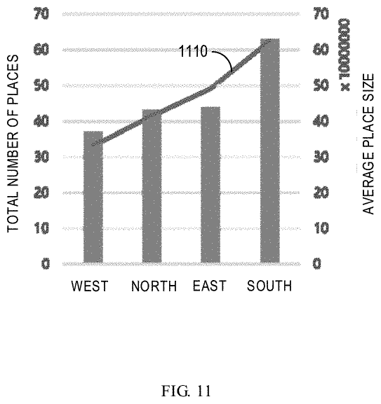

FIG. 9 illustrates example popularity level 130 under different place coverage rates of a product in a northern division. As shown, the bars corresponding to the following coverage rate or interval including “0,” “0-0.1,” “0.1-0.2,” “0.2-0.3,” “0.3-0.4,” and “0.4-0.5” in the northern division indicate the popularity level 130 under the respective place coverage rates in the northern division. Moreover, in the example of FIG. 9, the average popularity level of the product is 0.003 (shown in a dotted line). As can be seen clearly from FIG. 9, as the place coverage rate of the product in the northern division is increased, the product popularity level 130 is increased remarkably. The underlying reasons are illustrated with reference to FIGS. 10 and 11.

FIG. 10 illustrates example place coverage rates in respective months after a product has been supplied according to embodiments of the present disclosure. As shown, the curve 1010 represents a month-varying curve of the place coverage rate in an eastern division; the curve 1020 represents a month-varying curve of the place coverage rate in a southern division; the curve 1030 represents a month-varying curve of the place coverage rate in a western division; and the curve 1040 represents a month-varying curve of the place coverage rate in a northern division. As can be seen from FIG. 10, the place coverage rate of the product in the northern division is the lowest among the four divisions, in particular, the month when the product began to be supplied (i.e., the first month in FIG. 10). That is, the place coverage rate in the northern division is the “short board” among the four divisions, which lowers the product supply.

FIG. 11 illustrates example total numbers of places and example average place sizes in four divisions according to embodiments of the present disclosure. As shown, the respective bars corresponding to the western, northern, eastern, and southern indicate total numbers of places in the four divisions, and the curve 110 represents the connection of the total average place size of each division. As can be seen from FIG. 11, the northern division has a subtle difference between the northern division the total number and size of places in the eastern division and the total number and size of places in the eastern division, but the place coverage rate of the product in the northern division is the lowest among the four divisions (see FIG. 10). Thus, when the place coverage rate of the product in the northern division is increased, the supply intensity of the product will be increased in the whole area, and the popularity level 130 will be increased accordingly. Therefore, the statistical analysis conclusion as obtained from the data and the bar graphs is consistent with the causal provided by the causal structure learning module (or data processing model 120).

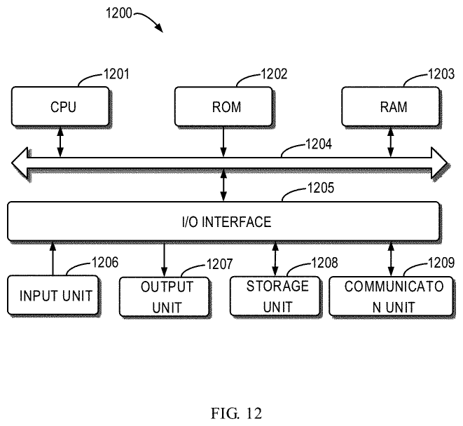

FIG. 12 illustrates a block diagram of an example device 1200 that can be used to implement the embodiments of the present disclosure. In some embodiments, the device 1200 may be an electronic device which may be used to implement the computing device 110 in FIG. 1. As shown, the device 1200 includes a central processing unit (CPU) 1201 which performs various appropriate actions and processing, based on a computer program instruction stored in a read-only memory (ROM) 1202 or a computer program instruction loaded from a storage unit 1208 to a random access memory (RAM) 1203. The RAM 1203 stores therein various programs and data required for operations of the device 1200. The CPU 1201, the ROM 1202 and the RAM 1203 are connected via a bus 1204 with one another. An input/output (I/O) interface 1205 is also connected to the bus 1204.

The following components in the device 1200 are connected to the I/O interface 1205: an input unit 1206 such as a keyboard, a mouse and the like; an output unit 1207 including various kinds of displays and a loudspeaker, etc.; a storage unit 1208 including a magnetic disk, an optical disk, and etc.; a communication unit 1209 including a network card, a modem, and a wireless communication transceiver, etc. The communication unit 1209 allows the device 1200 to exchange information/data with other devices through a computer network such as the Internet and/or various kinds of telecommunications networks.

Various processes and processing described above, e.g., the example method or process 200, 400, 500 and 600, may be executed by the processing unit 1201. For example, in some embodiments, the example method or process 200, 400, 500 and 600 may be implemented as a computer software program that is tangibly included in a machine readable medium, e.g., the storage unit 1208. In some embodiments, part or all of the computer programs may be loaded and/or mounted onto the device 1200 via ROM 1202 and/or communication unit 1209. When the computer program is loaded to the RAM 1203 and executed by the CPU 1201, one or more steps of the example method or process 200, 400, 500 and 600 as described above may be executed.

As used herein, the term “includes” and its variants are to be read as open terms that mean “includes, but is not limited to.” The term “based on” is to be read as “based at least in part on.” The term “one embodiment” and “the embodiment” are to be read as “at least one embodiment.” The terms “first,” “second,” and the like may refer to different or same objects. Other definitions, explicit and implicit, may be included in the context.

As used herein, the term “determining” covers various acts. For example, “determining” may include operation, calculation, process, derivation, investigation, search (for example, search through a table, a database or a further data structure), identification and the like. In addition, “determining” may include receiving (for example, receiving information), accessing (for example, accessing data in the memory) and the like. Further, “determining” may include resolving, selecting, choosing, establishing and the like.

It should be noted that the embodiments of the present disclosure can be implemented in software, hardware, or a combination thereof. The hardware part can be implemented by a special logic; the software part can be stored in a memory and executed by a suitable instruction execution system such as a microprocessor or special purpose hardware. Those skilled in the art would appreciate that the above apparatus and method may be implemented with computer executable instructions and/or in processor-controlled code, and for example, such code is provided on a carrier medium such as a programmable memory or an optical or electronic signal bearer.

Further, although operations of the method according to the present disclosure are described in a particular order in the drawings, it does not require or imply that these operations are necessarily performed according to this particular sequence, or a desired outcome can only be achieved by performing all shown operations. On the contrary, the execution order for the steps as depicted in the flowcharts may be varied. Alternatively, or additionally, some steps may be omitted, a plurality of steps may be merged into one step, or a step may be divided into a plurality of steps for execution. It should also be noted that the features and functions of two or more units of the present disclosure may be embodied in one apparatus. In turn, the features and functions of one unit described above may be further embodied in more units.

Although the present disclosure has been described with reference to various embodiments, it should be understood that the present disclosure is not limited to the disclosed embodiments. The present disclosure is intended to cover various modifications and equivalent arrangements included in the spirit and scope of the appended claims.

I/We claim:

1. A method of information processing, comprising:
obtaining a popularity level of a product and values of a plurality of attributes associated with the product;
determining a plurality of influence factors of the plurality of attributes on the popularity level of the product by applying the popularity level and the values of the plurality of attributes to a data processing model; and
determining, based on the plurality of influence factors, to adjust at least one attribute of the plurality of attributes to increase the popularity level of the product.

2. The method of claim 1, wherein obtaining the values of the plurality of attributes comprises:
obtaining values of attributes of a first attribute set associated with a plurality of competing products for the product.

3. The method of claim 2, wherein obtaining the values of the attributes of the first attribute set comprises:
determining a plurality of characteristics common to the product and the plurality of competing products;
determining characteristics from the plurality of characteristics, the characteristics of each of the plurality of competing products having the same values as the product;
dividing, based on different combinations of the characteristics, the plurality of competing products into a plurality of product groups; and
obtaining values of attributes in a plurality of attribute groups corresponding to the plurality of product groups.

4. The method of claim 3, wherein each of the plurality of attribute groups comprises at least one of the following:
the number, average user cost, and an average popularity level of competing products in one of the plurality of product groups.

5. The method of claim 1, wherein obtaining the values of the plurality of attributes comprises:
obtaining values of attributes of a second attribute set associated with a user cost strategy of the product.

6. The method of claim 5, wherein the attributes of the second attribute set comprise at least one of the following:
an average user cost of the product over a period; and
a ratio of an average user cost of the product to an average user cost of peer products of a plurality of competing products, the product and the plurality of competing products having a plurality of characteristics in common, the plurality of characteristics of the peer products having the same values as the product.

7. The method of claim 5, wherein the attributes of the second attribute set comprise at least one of the following:
user cost elasticity, user cost elasticity considering time delay, relative user cost elasticity, relative user cost elasticity considering time delay, a maximum fluctuation value of user cost, a relative maximum fluctuation value of user cost, an average fluctuation value of user cost, a relative average fluctuation value of user cost, an adjustment frequency of user cost, a user cost difference, and a relative user cost difference.

8. The method of claim 1, wherein obtaining the values of the plurality of attributes comprises:
obtaining values of attributes of a third attribute set associated with a supply strategy of the product.

9. The method of claim 8, wherein the attributes of the third attribute set comprise at least one of the following:
a season when the product is first supplied;
a ratio of the number of places where the product is supplied to a total number of places in a geographical area comprising a plurality of geographical divisions;
a ratio of the number of places where the product is supplied to a total number of places in each of the plurality of geographical divisions;
the number of geographical divisions where the product is supplied; and
an average magnitude of places where the product is supplied in each of the plurality of geographical division.

10. The method of claim 1, wherein obtaining the values of the plurality of attributes comprises:
preprocessing raw data associated with the product;
creating the plurality of attributes based on original attributes in the preprocessed data; and
determining the values of the plurality of attributes based on the preprocessed data.

11. The method of claim 1, wherein determining to adjust the at least one attribute comprises:
ranking the plurality of influence factors in terms of magnitude;
determining, based on a result of the ranking, a predetermined number of attributes corresponding to the predetermined number of influence factors; and
determining to adjust the predetermined number of the attributes to increase the popularity level of the product.

12. The method of claim 1, wherein the data processing model comprises a causal model.

13. An electronic device, comprising:
at least one processor; and
at least one memory comprising computer program instructions, the at least one memory and the computer program instructions being configured, together with the at least one processor, to cause the electronic device to:
obtain a popularity level of a product and values of a plurality of attributes associated with the product;
determine a plurality of influence factors of the plurality of attributes on the popularity level of the product by applying the popularity level and the values of the plurality of attributes to a data processing model; and
determine, based on the plurality of influence factors, to adjust at least one attribute of the plurality of attributes to increase the popularity level of the product.

14. The electronic device of claim 13, the electronic device is caused to wherein obtaining the values of the plurality of attributes comprises:
obtaining values of attributes of a first attribute set associated with a plurality of competing products for the product.

15. The electronic device of claim 14, wherein the electronic device is caused to obtain the values of the attributes of the first attribute set by:
determining a plurality of characteristics common to the product and the plurality of competing products;
determining characteristics from the plurality of characteristics, the characteristics of each of the plurality of competing products having the same values as the product;
dividing, based on different combinations of the characteristics, the plurality of competing products into a plurality of product groups; and
obtaining values of attributes in a plurality of attribute groups corresponding to the plurality of product groups.

16. The electronic device of claim 15, wherein each of the plurality of attribute groups comprises at least one of the following:
the number, average user cost, and an average popularity level of competing products in one of the plurality of product groups.

17. The electronic device of claim 13, wherein the electronic device is caused to obtain the values of the plurality of attributes by:
obtaining values of attributes of a second attribute set associated with a user cost strategy of the product.

18. The electronic device of claim 17, wherein the attributes of the second attribute set comprise at least one of the following:
an average user cost of the product over a period; and
a ratio of an average user cost of the product to an average user cost of peer products of a plurality of competing products, the product and the plurality of competing products having a plurality of characteristics in common, the plurality of characteristics of the peer products having the same values as the product.

19. The electronic device of claim 17, wherein the attributes of the second attribute set comprise at least one of the following:
user cost elasticity, user cost elasticity considering time delay, relative user cost elasticity, relative user cost elasticity considering time delay, a maximum fluctuation value of user cost, a relative maximum fluctuation value of user cost, an average fluctuation value of user cost, a relative average fluctuation value of user cost, an adjustment frequency of user cost, a user cost difference, and a relative user cost difference.

20. A computer program product being tangibly stored on a non-transitory computer readable medium and comprising machine executable instructions, which, when executed, causing a machine to:
obtain a popularity level of a product and values of a plurality of attributes associated with the product;
determine a plurality of influence factors of the plurality of attributes on the popularity level of the product by applying the popularity level and the values of the plurality of attributes to a data processing model; and
determine, based on the plurality of influence factors, to adjust at least one attribute of the plurality of attributes to increase the popularity level of the product.
